(19) United States
(12) Patent Application Publication
(10) Pub. No.: US 2007/0208868 A1
(43) Pub. Date: Sep. 6, 2007

(54) Electronic Communication Relationship Management System And Methods For Using The Same

(76) Inventors: John T. Kidd, Atlanta, GA (US); Ralph V. Kidd, Atlanta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/681,959

(22) Filed: Mar. 5, 2007

Related U.S. Application Data
(60) Provisional application No. 60/778,689, filed on Mar. 3, 2006.

(51) Int. Cl. G06F 15/16

(52) U.S. Cl. 709/229

(57) ABSTRACT

A method performed by a validator computer system for facilitating electronic communications from a sender to an electronic message program associated with a recipient. The method includes registering the sender in the validator system, registering the recipient in the validator system, and receiving approval from the recipient to designate the sender as an authorized sender for the recipient in the validator system. The method further includes designating the approved sender as an authorized sender for the recipient in the validator system in response to the approval from the recipient and communicating with a message filter associated with the message program associated with the recipient to add the sender to an authorized sender list of the filter.

### CROSS-REFERENCE TO RELATED APPLICATION

The following application is a non-provisional patent application claiming priority to U.S. Provisional Patent Application No. 60/778,689, filed Mar. 3, 2006.

### BACKGROUND OF THE INVENTION

The present invention relates to electronic communication systems and, more specifically, to electronic communication systems including a validator registering particular senders and recipients of e-mail and communicating with message filters associated with the recipients for ensuring that e-mails from the senders pass to in-boxes of the recipients.

It is often challenging for a company to establish and maintain e-mail communications with their customers. In a common scenario in which a relationship for e-mail communication is established, a customer enrolls with a company's website as part of purchasing a service or product or seeking information about the service or product. During the enrollment process, the customer may be asked to complete an on-line form requesting an e-mail address so the company can contact the user in the future regarding various matters including services, products, information, and sales. To complete the enrollment process, the company may send an e-mail to the submitted e-mail address to ensure the address is valid and the e-mail program accepts e-mails from them. Several undesirable scenarios often play out during final steps of such enrollment processes and with most any situation in which senders of e-mail want their messages to pass to the in-box of recipients that want the messages.

For example, the e-mail sent to the enrollee may include a link that the enrollee selects to verify that the e-mail was received thereby showing the proper e-mail communication exists at the time. Alternatively, the enrollee may be asked to reply to the e-mail thereby notifying the sender company that the e-mail was successfully received. If the enrollee has a spam filter associated with their e-mail program, the filter may divert the verification e-mail from the company to a spam folder rather than allowing it to pass to the enrollee's in-box. If so, and the enrollee does not review his spam folder, the enrollee will never receive the e-mail, resulting in a failed enrollment and potential loss of the company-customer relationship.

Even if an enrollment is completed by the enrollee responding to the verification e-mail, post-enrollment problems sometimes occur in traditional e-mail systems. For example, sometimes customers adjust settings on their filters thereby inadvertently blocking e-mails from the company. If the customer does not review the spam folder of their spam filter, they will not receive the e-mail and the spam filter may be configured to delete the e-mail.

Further, senders such as companies sometimes change their e-mail address to a previously unused address, such as changing the preamble and maintaining the domain. For instance, a company may change the address they use to communicate with customers from support@samplecompany.com to customer-service@samplecompany.com. If the new address is not recognized by the spam filter, e-mails from the new address will be sent to the spam folder.

### SUMMARY OF THE INVENTION

The present invention relates to a method performed by a validator computer system for facilitating electronic communications from a sender to an electronic message program associated with a recipient. The method includes registering the sender in the validator system, registering the recipient in the validator system, and receiving approval from the recipient to designate the sender as an authorized sender for the recipient in the validator system. The method further includes designating the approved sender as an authorized sender for the recipient in the validator system in response to the approval from the recipient and communicating with a message filter associated with the message program associated with the recipient to add the sender to an authorized sender list of the filter.

In another aspect, the present invention relates to a computer system for ensuring electronic communications from a sender are received to an in-box of an electronic message program associated a recipient. The computer system includes a processor running at least one program, a database connected to the processor for storing information received from the processor and releasing the stored information to the processor upon request of the processor, and an input/output interface connected to the processor by way of an input/output data bus for connecting the processor to a wide area network. The computer system further includes a memory connected to the processor and an an e-mail validation program stored in the non-volatile memory and ran by the processor wherein the processor running the program connects to the wide area network via the input/output interface, requests and receives registration information from a sender via the wide area network, and stores the registration information received from the sender in the database. The processor running the program further requests and receives registration information from a recipient over the wide area network, stores the registration information received from the recipient in the database, and receives approval from the recipient to designate the sender as an authorized sender for the recipient in the validator system over the wide area network. The processor also designates the sender as an authorized sender for the recipient in the database in response to the approval from the recipient and communicates with a message filter associated with the message program associated with the recipient to add the sender to an authorized sender list in the filter.

In yet another aspect, the present invention relates to a communication system for ensuring electronic communications from a sender are received to an in-box of an electronic message program associated a recipient including a wide area network, a sender computer operatively connected to the wide area network, a recipient computer operatively connected to the wide area network, and an electronic message program associated with the sender computer. The communication system further includes an electronic message filter associated with the electronic message program and a validating computer connected to the wide area network including a processor running at least one program and a database connected to the processor. The validating computer further includes an e-mail validation program stored in the non-volatile memory and ran by the processor wherein the processor running the program connects to the wide area network via the input/output interface, requests and receives registration information from a sender via the wide area network, stores the registration information received from the sender in the database, and requests and receives registration information from a recipient over the wide area network. The processor running the program also stores the registration information received from the recipient in the database, receives approval from the recipient to designate the sender as an authorized sender for the recipient in the validator system over the wide area network, designates the sender as an authorized sender for the recipient in the database in response to the approval from the recipient, and communicates with a message filter associated with the message program associated with the recipient to add the sender to an authorized sender list in the filter.

In still another aspect, the present invention relates to a method performed by a validator computer system for facilitating electronic communications from a sender to an electronic message program associated with a recipient. The method includes communicating with the electronic message program associated with the recipient to procure configuration information regarding the filter for facilitating communications between the validator system and the filter and to enable all electronic messages from the validator system to pass to whom the validator is sending the electronic messages, registering the sender in the validator system, and registering the recipient in the validator system. The method further includes forming an alias e-mail address having a domain name of the validator system associated with a recipient having an actual e-mail address and storing the alias e-mail address and actual e-mail address and linking the addresses in a database of the validator system, receiving approval from the recipient to designate the sender as an authorized sender for the recipient in the validator system, and receiving an electronic message from a transmitter to the alias address of the recipient. The method also includes ensuring that the transmitter of the electronic message to the alias address associated with the recipient has been approved by the recipient an authorized sender for the recipient in the validator system and forwarding the electronic message to the recipient if the transmitter of the message has been approved by the recipient as authorized sender for the recipient in the validator system.

In another aspect, the present invention includes a computer-readable medium product having computer program logic embodied therein for facilitating electronic communications from a sender to an electronic message program associated with a recipient, the computer program logic stored on the computer-readable medium to perform a method including registering the sender in the validator system and registering the recipient in the validator system. The computer program logic is also stored on the computer-readable medium to receive approval from the recipient to designate the sender as an authorized sender for the recipient in the validator system, designate the approved sender as an authorized sender for the recipient in the validator system in response to the approval from the recipient, and communicate with a message filter associated with the message program associated with the recipient to add the sender to an authorized sender list of the filter.

### BRIEF DESCRIPTION OF THE DRAWINGS

FIG. 1 is a diagram of an electronic communications system according to the present invention.

FIG. 2 is a schematic of a Validator computer according to the present invention.

FIG. 3 is a flow chart showing a process by which a sender may register with the Validator.

FIG. 4 is a screen shot of a Web page form that the Validator may present to a registering sender.

FIG. 5 is a flow chart showing a process by which a recipient may register with the Validator.

FIG. 6 is a screen shot of a Web page form that the Validator may present to a registering recipient.

FIG. 7 is a flow chart showing a process by which a sender-recipient relationship may be created according to one embodiment of the present invention.

FIG. 8 is a flow chart showing a process by which a sender-recipient relationship may be created according to another embodiment of the present invention.

FIGS. 9-10 are screen shots of a two Web page forms that the Validator may present to a registered recipient for authorizing a sender according to one embodiment of the present invention.

FIG. 11 is a screen shot of a Web page form that the Validator may present to a registered recipient for authorizing a sender according to another embodiment of the present invention.

Corresponding reference characters indicate corresponding parts throughout the several views of the drawings.

### DETAILED DESCRIPTION OF THE DISCLOSURE

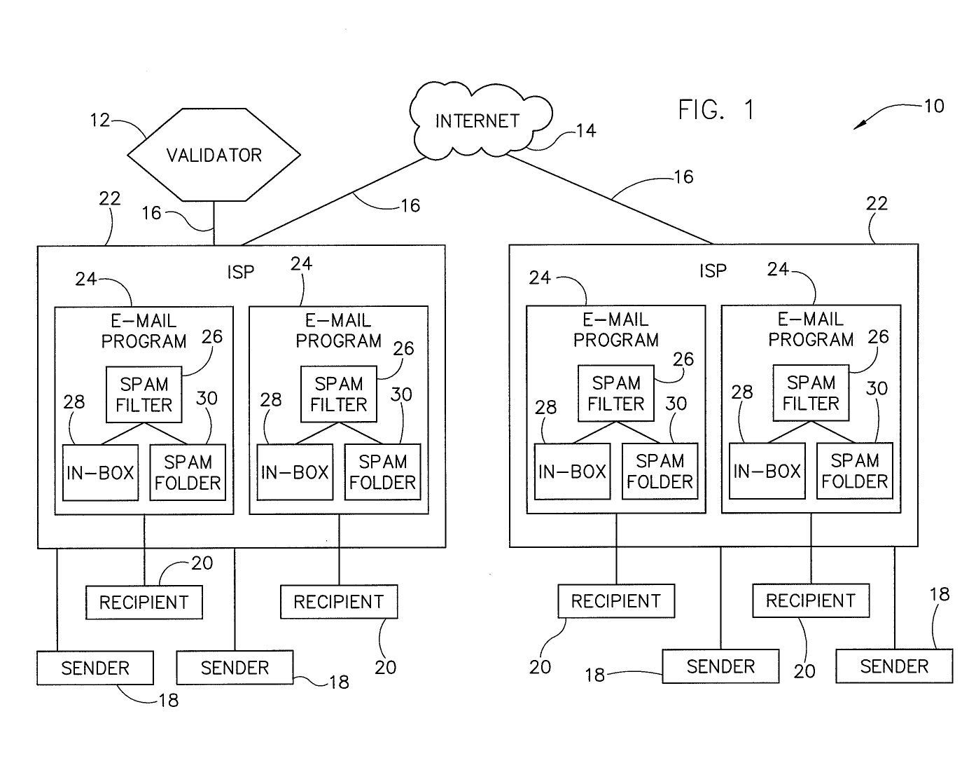

Referring to the figures, and more particularly to FIG. 1, an electronic communication system according to the present invention is designated in its entirety by reference number 10. The electronic communication system 10 includes an electronic relationship management subsystem 12, referred to as a Validator or VeriSpam. The Validator 12 may include a conventional computer, computer system, or computer device such as a server, as described in further detail below. The Validator 12 has a network interface (not shown) for connecting to a wide area network, such as the Internet 14. The Validator 12 is connected to the Internet by way of its network interface, a common access mode 16, such as cable or satellite, and an ISP 22, as described below.

The system 10 further includes computers of senders 18 and computers of recipients 20 connected to the Internet 14 by respective interfaces and access modes 16 for exchanging electronic messages, such as e-mail. Although users of the system 10 are separated into senders 18 and recipients 20 for reasons that will be apparent, members of both groups can send and receive electronic messages. Communications between the senders 18, the recipients 20, and the Validator 12 are transmitted to/from the Internet 14 via internet service providers 22 (ISPs). Each ISP 22 may be connected directly to the Internet 14 or to one or more upstream ISPs (not shown) connecting to the Internet. In one embodiment (not shown in detail), the Validator 12 is positioned within an ISP 22. Although a finite number of Validators 12, senders 18, recipients 20, and ISPs 22 is shown in the figures, the number of Validators, senders, and recipients that may be part of the system 10 is not limited. Further, the Validator 12, senders 18, and recipients 20 may be connected to the same or various ISPs 22 in any combination. For example, although FIG. 1 shows the Validator 12 connected to an ISP 22 that some of the senders 18 and recipients 20 are connected to, the Validator may be connected to an ISP to which none of the senders and recipients are connected. As another example, one of the ISPs to which one or more recipients 20 are connected to may not have any senders 18 connected to it.

The system 10 further includes an electronic message program, such as an e-mail program 24, associated with each recipient 20 by which the recipients receive electronic communications. A message filter, such as a spam filter 26, may be associated with each e-mail program 24. As well known in the art, spam filters 26 are software programs or applications processing e-mail sent to the e-mail program 24 of a recipient 20 including segregating the e-mail according to specified criteria. Although the e-mail programs 24 and spam filters 26 are shown positioned together and within the ISPs 22, it will be appreciated that the e-mail programs and spam filters may be positioned together or separate elsewhere in the system 10. For example, spam filters 26 may be installed on a home personal computer (PC) (not shown in detail) of a recipient 20 operatively connected to an e-mail program in the PC or within the e-mail program. References in the specification and claims to communications with message filters such as spam filters may be interpreted as including meaning communications with the entity maintaining the filters, such as an ISP. Similarly, references in the specification and claims to communications with ISPs may be interpreted as including communications with the programs, filters, and/or other devices maintained or operated by the ISP, such as the message filters.

Each e-mail program 24 includes an in-box 28 or other preferred box or folder and a spam folder 30. The spam filter 26 associated with the respective e-mail program receives all e-mails going to the e-mail program and passes the e-mails to the in-box 28 or the spam folder 30 depending on characteristics of the e-mails (e.g., sender name, subject, and content) in relation to the filtering criteria. As described in the Background of the Invention section above, recipients 20 sometimes do not receive desired e-mails from known and trusted senders 18 in their in-box 28 because the e-mails are transferred to their spam folder 30. In those cases, in order to retrieve the rejected e-mail, the recipient 20 must check their spam folder 30 before the spam filter deletes the e-mail. In order to receive future e-mails from the trusted sender 18, the recipient 20 must continuously check their spam folder 30 or adjust criteria settings on their spam filter 26. These traditional methods of dealing with spam filters 26 are arduous and often ineffective due in part to the disinclination of recipients 20 to check their spam folders 30 and adjust the their filter settings.

The Validator 12 establishes and manages relationships between the particular senders 18 and particular recipients 20 who have been authenticated by the Validator based on mutual agreement between particular senders and recipients. Further, the Validator 12 communicates with the spam filters 26 associated with the authenticated recipients 20 to ensure the recipients reliably receive desired messages from senders 18 with whom they have established relationships via the Validator. Senders 18 and recipients 20 who have registered with the Validator 12 for establishing these relationships may be referred to as members of the Validator. Senders 18 may include, for example, companies selling products or services on-line (e.g., via Internet 14) and wishing to communicate by e-mail with recipients 20 regarding their products and services. Recipients 20 may include, for example, consumers seeking products, services, and information on-line from one or more senders 18.

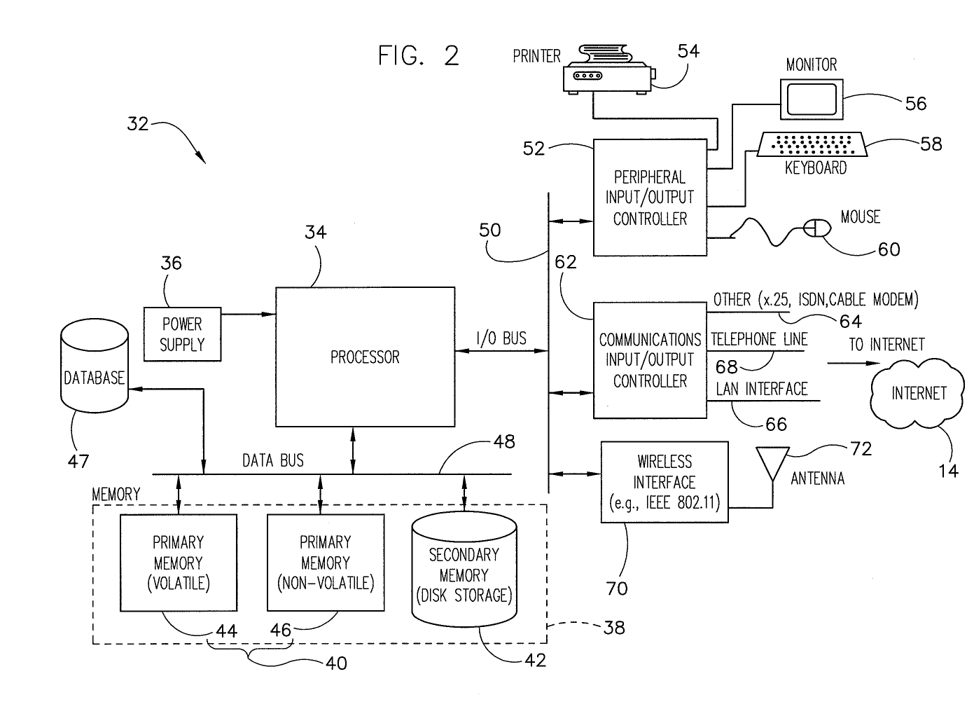

As shown in FIG. 2 and mentioned above, the Validator 12 may include a conventional computer, computer system, or computer device such as a server, collectively referred to as the computer 32. The computer 32 includes a processor 34, such as a microprocessor, which executes software instructions for carrying out steps of the Validator 12 during operation of the Validator as described in more detail below. The processor 34 receives power from a power supply 36 that may also provide power to the other components of the computer 32. The computer 32 also includes a memory 38 comprising primary memory 40 and secondary memory 42. The primary memory 40 may include volatile primary memory 44, such as random-access memory (RAM) or other forms of memory retaining contents only during operation of the computer. The primary memory 40 may also include non-volatile primary memory 46, such as flash memory or read-only memory (ROM), or other types of memory retaining contents whether the computer is running or turned off. The secondary memory 42 has disk storage for storing relatively large amounts of data. The secondary memory 42 may include a floppy disk, hard disk, compact disk, DVD, or other type of mass storage.

The secondary memory 42 may include or constitute a database or data repository or, alternatively, the computer 32 may include a database 47 separate from the memory 38. The separate database 47 may be connected to the processor 34 by way of the same internal data bus 48 connecting the memory 38 to the processor, as shown in FIG. 2, or by a separate internal data bus (not shown). Exemplary internal data buses 48 include those that are 16 or 32 bits-wide and in parallel. The processor 34 conveys data and program instructions to and from the memory 38 by way of the internal data bus 48.

The computer 32 may also include or incorporate various peripherals or external devices. The processor 34 may be connected to the peripherals by way of an input/output (I/O) data bus 50. The peripherals may include a peripheral I/O controller 52 as an interface between the processor 34 and I/O devices 54, 56, 58, 60. Exemplary peripheral I/O controllers 52 include those configured or programmed according to the RS-232, RS422, DIN, or USB standards. The I/O devices may include local printers 54, a monitor 56, a keyboard 58, and a mouse 60 and/or other pointing devices (e.g., roller ball, track pad, or joystick).

The computer 32 may include or incorporate a communications 1/0 controller 62 operating as an interface (i.e., network interface) with one or more external communication networks such as a local area network (LAN) or the Internet 14. The communications I/O controller 62 interfaces with the external networks via access modes 16, such as cable lines 64, Ethernet lines 66 for wired connection to a LAN, and telephone lines 68.

In one embodiment, the processor 34, the memory 38, the database 47, and the communications I/O controller 62 are part of a server connected to the Internet 14, a LAN, or other network via the communications I/O controller. For embodiments in which the server is connected to a LAN, the server may be linked to local clients (e.g., local client computers), networked printers, and the Internet via the LAN. The server may connect to remote clients (i.e., remote client computers) through the LAN-to-Internet link.

The computer 10 may also include or incorporate a wireless I/O controller 70 or network interface linking the processor 34 to the Internet 14 via satellite or a wireless LAN such as IEEE 802.11 (i.e., Wi-Fi). Wi-Fi is a registered trademark of the Wireless Ethernet Compatibility Alliance, Inc., now the Wi-Fi Alliance, of Austin, Tex. Other wireless protocols include 802.15.4 protocol and standard 3G wireless telecommunications protocols, such as CDMA2000 1x EV-DO, GPRS, and W-CDMA. In one embodiment (not shown), the communications I/O controller 62 performs the functions of a wireless I/O controller, linking the processor 34 to a wireless network. As will be appreciated by those skilled in the art, the computer 32 may include or incorporate various intermediate devices for connecting the communications I/O controller 62 and wireless I/O controller 70 to external networks, such as modems (not shown in detail) and routers or antennas 72. Any of these devices may be used by the computer 32 to access the Internet 14, intranets, LANs, or other data communication facilities.

The Validator 12 may include other components and architectures without departing from the scope of the present invention. Accordingly, the embodiments of the computer 32 described with respect to FIG. 2 can be modified in various ways without departing from the scope of the present invention. Operating programs (i.e., software) of the Validator 12 may be installed in and ran from the memory 38. Information supporting operations of the Validator 12, including information received from members (e.g., registered senders 18 and recipients 20), may be stored in the aforementioned memory 38 and/or database 47.

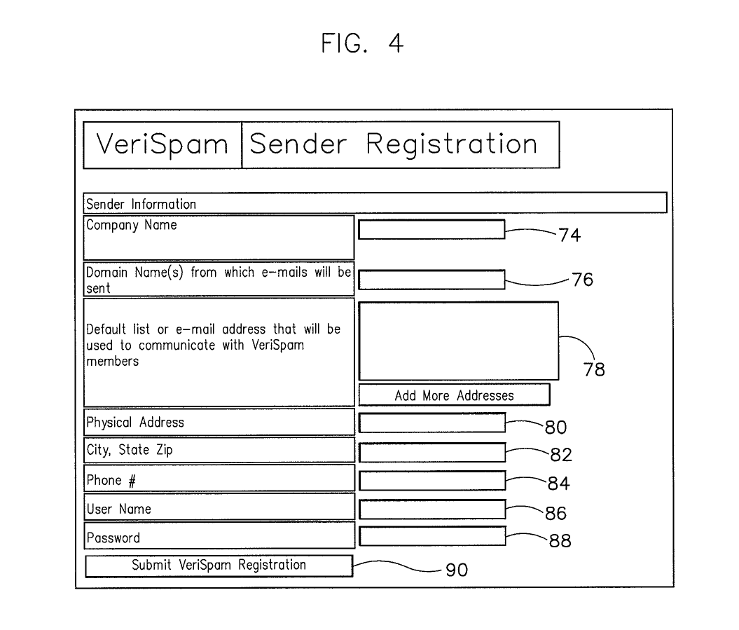

As described above, the Validator 12 establishes and maintains relationships between its registered members and may link any two members in a relationship when authorized or approved by each of those members or at least authorized by the registered recipient 20. The Validator 12 includes one or more World Wide Web applications installed in the memory 38 (e.g., the volatile primary memory 44). Web applications are applications or software installed on computers or servers for communicating with users or clients over the Internet 14. Through a Web application, a programmer may develop Web pages that are a part of the Web application for communicating with potential and registered members and communicate with those entities. The computers of the senders 18 and the recipients 20 include Web browsers for accessing the Internet 14 and Web pages available over the Internet from hosts such as the Validator 12. FIGS. 4, 6, 9, 10, and 11 show exemplary Web pages (i.e., screen shots of the Web pages) formed through one of the Web applications of the Validator 12 for communicating with senders 18 and recipients 20. These Web pages will be described in further detail below.

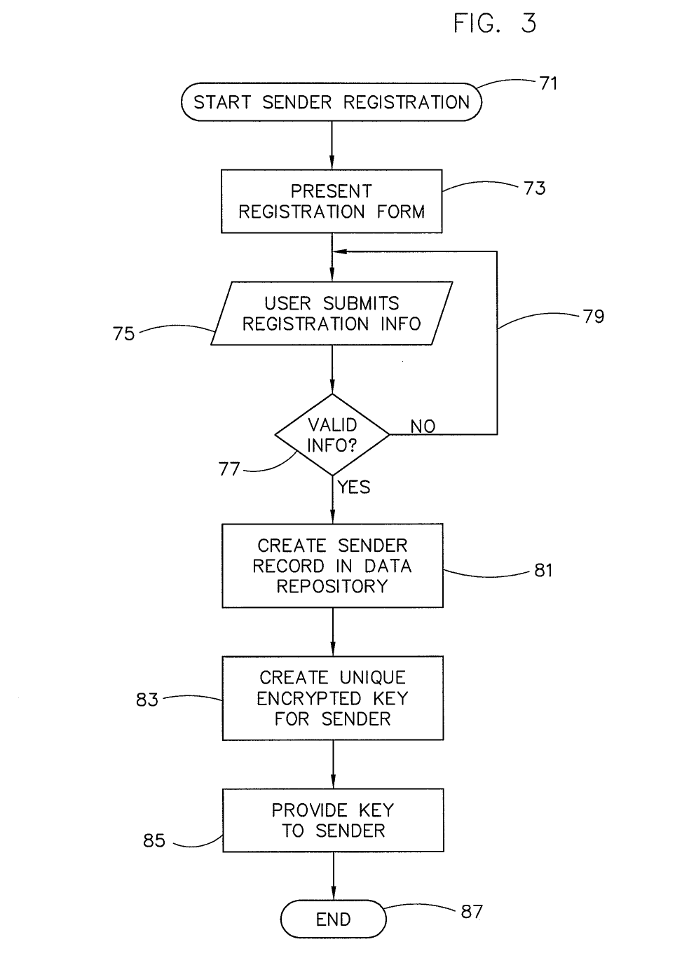

FIG. 3 shows a flow chart of the steps (odd reference numbers 71-87) for creating an account for a sender 18 in the Validator 12. Although, the sender 18 will need to provide e-mail addresses of one or more recipients 20 for using the Validator 12, the registering sender 18 does not need to provide this information in order to register. The Validator 12 is configured to allow the sender 18 to provide recipient 20 e-mail addresses during and/or after registration and change (including adding and removing) the recipient e-mail addresses associated with their (i.e., the sender's) account as desired thereafter.

An exemplary scenario in which a registering sender 18 may register without providing recipient e-mail addresses is when the registering sender is registering before they have identified intended recipients 20. Such pre-relationship registration by the registering sender 18 establishes an account with the Validator 12 that the sender can use in its process of enrolling customers (i.e., to-be recipients 20). For instance, when a customer or potential customer accessing a Web site of the sender 18 wants more information about a product or service of the sender, the sender's Web site may be configured to provide the to-be recipient 20 with information identifying their Validator 12 account (e.g., via an account number associated with the sender) or to include a link to the Validator. Such links to the Validator 12 can link to a Web page of the Validator that is general or that is dedicated to the account of the sender 18. When a recipient 20 accesses the Validator 12, whether in connection with interacting with a sender 18, the recipient can edit their previously established account, or create an account if they do not already have one, and identify one or more senders as authorized or approved senders of e-mail to the recipient. For example, a Web page of the sender 18 presented to the recipient 20 may prompt the recipient to enter their Validator 12 account information or link to the Validator for creating an account.

For registering an aspiring sender, the Validator 12 is configured to obtain registration information or credentials and authentication information associated with the aspiring sender. As shown in FIG. 3, the registration process for the aspiring and now registering sender 18 starts (step 71) with the registering sender accessing a Web page form generated and presented by the Validator 12 (step 73). FIG. 4 shows an exemplary Web page form that the Validator 12 may present to registering senders. The form includes fields into which the registering sender 18 enters relevant information (step 75). The Validator 12 in turn records the information submitted by the registering sender 18 in its memory 38 or database 47.

As shown in the FIG. 4, the registration information includes a name 74 of the entity seeking to become a registered sender 18, such as the name of an individual person or a company. The registration information for the sender 18 also includes one or more domain names 76 from which the registering sender plans to send e-mails. For example, if the registering sender plans to send e-mails using the addresses, sender@senderdomain.com and sender@senderdomain.net, then the registering sender would enter senderdomain.com and senderdomain.net into the domain name(s) field 76. The registration information for the sender 18 further includes a field 78 for entering one or more e-mail addresses that will be used to communicate with other members (i.e., recipients 20) of the Validator 12. Thus, considering the exemplary addresses given above in the paragraph, the registering sender 18 in this example would enter sender@senderdomain.com and sender@senderdomain.net into the e-mail addresses field 78.

The registration information for the sender 18 may also includes a physical street address 80 (or post office box, etc.) for the sender, and their city/state/zip data 82. The registration information for the sender 18 may further include a phone number 84. The Validator 12 or administrators thereof may use the physical address and phone number information to contact the registering sender 18 during final stages of the registration process, as described below in more detail, or thereafter.

The particular aforementioned registration information for registering senders 18 is only exemplary and the Validator 12 may be configured to require different or additional information without departing from the scope of the present invention. For example, although associated fields are not shown in the registration form of FIG. 4, the Validator 12 may request information regarding the registering sender's 18 type of business (e.g., product or service they sell) and references for the sender, such as people from unaffiliated organizations that the Validator 12 may contact to determine if they can vouch for the sender's reputation).

As further shown in FIG. 4, authentication information includes a username 86 and a challenge/response and/or a password 88. In some embodiments, the Validator 12 may be programmed to provide registering parties (i.e., senders 18 and recipients 20) with an option of whether they want their authentication information to include password and/or challenge/response. These types of authentication or security features are well known in the art and are not limited to the exemplary types mentioned. For embodiments using usernames and passwords for authentication information, the Validator 12 may be configured to require that the username and password submitted by the registering sender 18 be within certain requirements, which is also well known in the art. For example, the Validator 12 may require that the username and password created by the registering sender 18 have a certain number of characters and that the username and password are different. The Validator 12 may require senders 18 to provide the correct username/password each time they log onto the Validator 12 after registration. For allowing access to the Validator 12, the Validator may require, along with or instead of the username/password authentication information from the sender 18, the sender to provide a unique encrypted key provided by the Validator to the sender as described in further detail below.

After the registration and authentication information has been entered by the sender 18, the sender may select a register button 90 positioned on the sender registration Web page. The Validator 12 is configured to process the registration information and authentication information provided by the registering sender 18 after they select the submit registration button 90. As part of processing the information that the registering sender 18 provided, the Validator 12 determines whether the provided information is valid (step 77 in FIG. 3). Specifically, the Validator 12 may be programmed with criteria to which the information provided by the registering sender 18 must conform. For example, the Validator 12 may be configured to ensure that the physical address provided in the address fields 80, 82 and the phone number provided in the corresponding field 84 match actual addresses and phone numbers, or at least that they are in a form required by the Validator 12 (e.g., phone number has ten digits). If the information provided by the registering sender 18 does not conform to the required standards of the Validator 12, then the Validator returns (step 79) the registering sender 18 to the step (step 75) of inputting the registration and authentication information. The Validator 12 may provide a message (not shown) informing the registering sender 18 that the information they provided was not in proper form and, perhaps, more specifically, advising them of the particular error in the information (e.g., “Please provide a valid area code for the phone number”).

The Validator 12 may also verify the accuracy of information provided by the registering sender 18 by communicating with the registering sender in a variety of ways without departing from the scope of the present invention. For example, the Validator 12 may send an e-mail to the e-mail address provided by the sender 18 having supplied registration information and request a response confirming accuracy of the information. The Validator 12 may also verify accuracy of supplied information by way of telephone, postal mail, or other modes of communication. After the registration information of the registering sender 18 has been verified, the Validator 12 updates data associated with the registering sender in the memory 38 or database 47 to indicate the verification. After the Validator 12 confirms that the information (e.g., registration and authentication information) provided by the registering sender 18 is valid and conforms to the standards of the Validator, the Validator records the information in the memory 38 or database 47 of the Validator 12 as a sender record (step 81).

As described above, the authentication information for the sender 18 may include a unique encrypted key generated by the Validator 12 (step 83). Technology for creating and using encrypted or secure access keys are well known in the art. Such keys may include one or more cookies that the Validator 12 generates and implants in the registering sender's computer. The Validator may present the key to the sender 18 (step 85) at any predetermined stage of the registration process. For example, the Validator 18 may present the key to the sender 12 around the time that the Validator is receiving and processing the registration/authentication information submitted by the sender 18 after the sender selects the submit registration button 90. As shown in FIG. 3, the Validator 12 may be configured to create the authentication key (step 83) and provide the key to the sender 18 (step 85) after the Validator has confirmed that the information supplied by the registering sender is valid (step 77) and after the Validator has created a sender record in the database 47 or memory 38 (step 81). The Validator 12 may be configured to transmit instructions to the sender 18 for interfacing with the Validator with the transmission of the key to the sender or before or after that transmission.

The Validator 12 may be configured to receive information (e.g., registration information) provided manually by the sender 18 or recipient 20, such as entered by typing. Alternatively, the Validator 12 may be configured to receive information automatically from pre-existing data or other methods of data procurement known in the art. As an example of automatic procurement, the Validator 12 may be configured to request and receive registration information from data already stored on the computer of a registering sender 18 or recipient 20. The Validator 12 may also request and receive registration information associated with a particular sender 18 or recipient 20 from a third party, such as from a publicly or privately available database. For example, the Validator 12 may request and receive registration information for a particular registering party from an ISP 22 serving the registering sender with consent of the registering party.

In one embodiment of the present invention, the process of registering the sender 18 is complete (step 87) once the Validator 12 has received the registration information and authentication information (step 75), confirmed appropriate form of that information (step 77), created the sender account (step 81), and sent the authentication key (step 85) to the registering sender. In some embodiments of the present invention, the end (step 87) of the registration process occurs when the registering sender 18 receives and replies to the one or more validating communications described above (e.g., validation e-mail or letter).

The completed sender 18 account in the Validator 12 (not including recipient e-mail addresses which may have been entered by the sender and stored by the Validator) may be called a parent record. Each sender 18 has a parent record. A child record is created for a sender 18 based on and linked to the parent record for every recipient 20 added to the sender's account. The Validator 12 may be configured to use the parent record as a template for forming child records and the child records may be altered and unique from each other in various ways in addition to the differing recipient e-mail addresses. For example, a parent record of an account of a sender 18 may include all of the contact information for the sender and many domains and e-mail addresses they plan to use for communicating with various recipients 20. When adding recipients to their account, the sender 18 in this example may wish to use certain of their domains and e-mail addresses with some recipients 20 and other domains and e-mails addresses with other recipients.

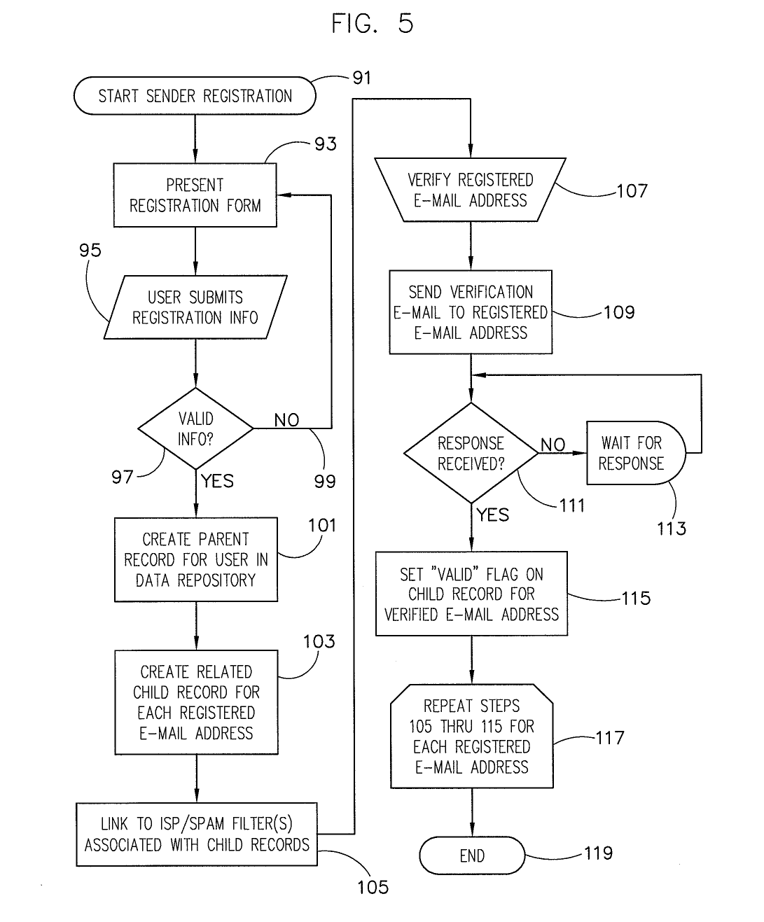

FIG. 5 shows a flow chart of the steps (steps 91-119, odd numbers) for creating an account for a recipient 20 in the Validator 12. Eventually, the recipient 20 will need to provide domains or e-mail addresses of one or more senders 18 from whom the recipient agrees to accept e-mails to use the Validator 12. However, as shown in FIG. 5, the registering recipient 20 does not need to provide this information during their registration. The recipient 20 may provide sender 18 domains or e-mail addresses for association with their Validator account during and/or after registration with the Validator and may change (including adding and removing) the sender addresses as desired thereafter. An exemplary scenario in which a registering recipient 20 may register without providing sender e-mail addresses is when the registering recipient is registering before they have identified intended senders. Such pre-relationship registration by the registering recipient 20 establishes an account with the Validator 12 that the recipient can quickly and easily use to approve senders in the future. For example, the recipient 20 can quickly and easily use their Validator account when required by a vendor that uses the Validator with respect to their e-mail communications with enrollees of their Web site. For instance, a registered recipient 20 may find it useful to already have an account when they are enrolling on-line with a sender 18 requiring a Validator account as described above regarding sender registration. In such cases, and especially if the recipient 20 expects to perform multiple such enrollments, the recipient can save time and effort by creating a Validator 12 account in advance of actual use of the account.

The recipient 20 may register with the Validator in response to a request from a particular sender 18. For example, as described in the immediately preceding paragraph, some senders 18 may require that a customer (i.e., a to-be recipient 20) for their services register with the Validator 12. Accordingly, the customer may access an on-line registration Web page of the Validator 12 as described herein.

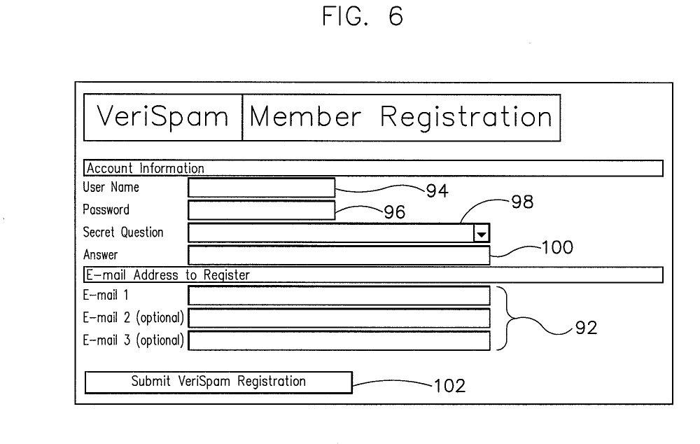

For registering a recipient-to-be wanting to receive e-mails from one or more senders 18, the Validator 12 is configured to obtain registration information and authentication information associated with that recipient 20. The registration process starts (step 91 in FIG. 5) with the registering recipient 20 accessing a Web page form generated and presented by the Validator 12 (step 93). FIG. 6 shows an exemplary Web page form that the Validator 12 may present to the registering recipient 20. The form includes fields into which the registering recipient 20 enters relevant information (step 95). The Validator 12 records the information provided by the recipient 20 in its memory 38 or database 47.

As shown in the FIG. 6, the registration information the Validator 12 requires of the registering recipient 20 includes at least one e-mail address 92 to which the recipient agrees to receive e-mails from particular senders 18. The particular registration information that the Validator 12 may be configured to collect from a registering recipient 20 is only exemplary and the Validator may be configured to require additional information without departing from the scope of the present invention. For example, the Validator 12 may request information regarding the registering the recipient's name (e.g., company or individual name), physical street address and phone number, although associated fields are not shown in the registration form of FIG. 6. The Validator 12 or administrators thereof may use the physical address and phone number information to contact the registering recipient 20 during final stages of the registration process or thereafter as described further below.

As further shown in FIG. 6, authentication information that the Validator may collect from the recipient 20 includes a username 94 and a password 96. The authentication information may also include a challenge, such as a secret or personal question 98, and a response 100 to that question. In some embodiments, the Validator 12 may be programmed to provide registering parties (i.e., senders 18 and recipients 20) with an option of whether they want their authentication information to include password and/or challenge/response. When passwords are used, the Validator 12 may be configured to require that the username and password created by the registering recipient 20 be within certain requirements as well known in the art and described above regarding sender registration. The Validator 12 may require recipients 20 to provide the correct authentication information each time they log onto the Validator 12.

After the registration and authentication information has been entered (step 95), the recipient 20 may select a register button 102 positioned on the sender registration Web page. The Validator 12 is configured to process the registration information and authentication information provided by the recipient 20 after the registering recipient has selected the submit registration button 102. As part of processing the information that the registering recipient 20 provided, the Validator 12 determines whether the provided information is valid (step 97). Specifically, the Validator 12 may be programmed with criteria to which the information provided by the registering recipient 20 must conform. For example, the Validator 12 may be configured to ensure that the e-mail address(es) provided in the corresponding fields 92 are in proper form. For instance, the Validator 12 may ensure that the e-mail addresses includes a preamble (e.g., JohnDoe) followed directly by an “at” symbol (@), which is in turn followed directly by a domain extension (e.g., example.com). The Validator 12 may confirm e-mail and other registration information provided by the registering recipient 20 by communicating with the recipient. For example, to confirm that e-mail addresses are correct, the Validator 20 may send a confirming e-mail to the provided addresses requesting reply for confirmation of successful receipt by the registering recipient 20. The Validator 12 may also verify accuracy of supplied registration information by way of telephone, postal mail, or other modes of communication when requesting such contact information from the registering recipient 20.

If the information provided by the registering recipient 20 does not conform to the required standards of the Validator 12, then the system returns (step 99) the registering recipient to the step (step 95) of inputting the registration and authentication information. The Validator 12 may provide a message (not shown) informing the registering recipient 20 that the information they provided was not in proper form and, perhaps, more specifically, advising them of the particular error in the information (e.g., “Please provide e-mail addresses in the following form: yourname@example.com”).

After the registration information and/or authentication information of the registering recipient 20 have been verified, the Validator 12 may update the database 47 or memory 38 to indicate verification of the same. If the Validator 12 confirms that the registration information and authentication information provided by the registering recipient 20 conforms to the standards of the Validator, the Validator records the information in the database 47 or memory 38 (shown in FIG. 2) of the Validator 12 as a sender record (step 101).

The authentication information for the recipient 20, in addition to the information provided by the registering recipient, may include a unique encrypted key generated by the Validator 12. The authenticating key for the recipient 20 may be generated and used in ways similar to the aforementioned processes by which encrypted keys are generated and used.

As described above, the Validator 12 may be configured to receive information (e.g., registration information) provided manually by the recipient 20 and/or sender 18. The Validator 12 may be configured to receive information automatically from pre-existing data from public or private sources as described above.

The completed recipient record created by the Validator (step 101 in FIG. 5) may be called a parent record. Each recipient 20 has a parent record. A child record is created (step 103) for a recipient 20 based on and linked to the parent record regarding every sender 18 that the recipient adds to their (i.e., the recipient's) account as an authorized or approved sender. The Validator 12 may be configured to use the parent record as a template for forming child records and the child records may be altered by the recipient 20 at any time and may be unique from each other. For example, a parent record of a recipient's account may include all of the registration information for the recipient including e-mail addresses to which they plan to receive e-mails. When adding a sender 18 to their account, the recipient 20 in this example may wish to allow e-mails from the particular sender to pass through the filter associated with one e-mail address but not through the filter associated with other of their e-mail addresses.

The process of registering the recipient 20 may further include linking each child record of the recipient to the associated filter (step 105). As described above, the filter(s) associated with the recipient's 20 one or more e-mail addresses may be installed within the ISP 22 that provides the recipient with access to the Internet and provides and services the recipient's e-mail accounts. Accordingly, for this linking step (step 105), the Validator 12 may contact the respective ISP(s) 22. The Validator 12 may be able to determine the appropriate ISP 22 to contact for each e-mail address of the recipient 20 based on the domain portion of the e-mail addresses. For example, the Validator 12 may know that a particular ISP 22 (e.g., SampleISP, Inc.) services all e-mail addresses having a certain domain extension (e.g., example.com).

In the linking step (step 105), the Validator 12 may further determine configuration information for the ISP 22 and/or interfaces between the Validator and the ISP. The Validator 12 may also provide and/or receive rules of engagement to/from the ISP 22, including communication instructions and protocols, for use in future communications. Future communications include, for example, communications from the Validator 12 for registering relationships between the recipient 20 and one or more senders 18 as described in detail below.

Although the Validator 12 does not have to be configured to require the registering recipient 20 to provide e-mail addresses of senders 20, for embodiments in which the Validator does require such e-mail information or when registering recipients voluntarily provide such e-mail information, the Validator may also verify the e-mail information (step 107). This verification (step 107) may include sending verification e-mails to the e-mail addresses (step 109) and determining whether a response was received (step 111). The Validator 12 may be programmed to wait for the response to the verification e-mail (step 113) for a particular amount of time or indefinitely. Because the process of registering a recipient 20 with the Validator does not require the recipient to provide e-mail addresses of senders 18, the process does not have to include verification of those addresses (steps 107, 109, 111). For cases in which the registering recipient 20 provides one or more sender e-mail addresses and the Validator 12 send a verification e-mail regarding each sender (step 109), the Validator 12 may be configured to flag the respective child record of the recipient when an e-mail is received from the respective sender in response to the verification e-mail (step 115). Also for such cases, the Validator 12 performs the verification step for each e-mail provided by the registering recipient 20 (step 117). In one embodiment, this repeat step (step 117) includes repeating the steps between and including linking to the ISP (step 105) and setting a “valid” flag in the Validator 12 regarding validated e-mail addresses (step 115).

In some embodiments of the present invention, the process of registering the recipient 20 is complete (step 119) after the Validator 12 has received the registration information and authentication information (step 93), confirmed appropriate form of that information (step 97), and created the recipient parent account (step 101). For the embodiment shown in FIG. 5, the process of registering the recipient 20 is complete (step 119) after the Validator 12 has received the registration and authentication information (step 93), confirmed appropriate form of that information (step 97), created the recipient parent and child accounts (steps 101, 103), linked child records to corresponding filters 26 (e.g., ISP-maintained filters) (step 105), verified sender e-mail addresses (steps 107, 109, 1 11), and flagged child records as valid (step 115) for each child record (step 117).

It is contemplated that the communication system 10 may be configured to allow a not-yet-registered recipient 20 to register with the Validator 12 by way of one or more Web pages (not shown) of the sender 18. For example, the sender 18 may create Web pages in their computer system designed to collect information (e.g., username and password) from recipients 18 desiring to create a recipient account with the Validator 12 and submit the collected credentials to the Validator for account creation. Administrators of the Validator 12 (e.g., programmers) can approve such sender-created pages before use. Alternatively, the Validator 12 may create all or some of such a Web page for the sender 18.

The Validator 12 may also interact with the computer system of the sender 18 so the registration form shown in FIG. 4 or parts thereof is displayed to the registering recipients 20 on a Web page of the sender or presented as a new pop-up box or window. For example, such a Validator page may pop up when customers of the sender 18 select a link on an enrollment form on the sender's Web site referring to registering with the Validator 12. In any event, the recipient 20 provides the information needed to create their account and the Validator 12 creates such account. It is further contemplated that, for embodiments in which the Web pages collecting credentials from the recipient 20 are running on a server of the sender 18, that server may be configured to automatically fill in any of the credentials that it has already procured from the recipient during the process of enrolling the recipient with their (i.e., the sender's) services.

After they are registered, senders 18 and recipients 20 may log onto the Validator 12 to change account information as desired. For example, a sender 18 moving its offices may access the Validator 12 for changing information associated with their location (e.g., items 80, 82, 84 in FIG. 4). It is contemplated that when a sender 18 or recipient 20 changes their account in substantive ways (e.g., changing e-mail addresses), the Validator 12 may be configured to announce the changes to related parties (e.g., authorized senders regarding a recipient making changes and recipients linked to senders making changes). The Validator 12 may make such announcements automatically or only if the changing party selects an option the Validator presents to the changing party to announce the change to one, all, or select related parties. Recipients 20 and senders 18 may change their accounts by creating new relationships with other senders and recipients, as described in more detail as follows.

Once a particular sender 18 and a particular recipient 20 register as members of the Validator 12, as described above, the Validator 12 may create a relationship between them. In most embodiments of the communication system 10, the Validator 12 is configured to create a relationship between a particular registered sender 18 and a particular registered recipient 20 after the particular recipient agrees in the Validator to receive e-mails from the sender.

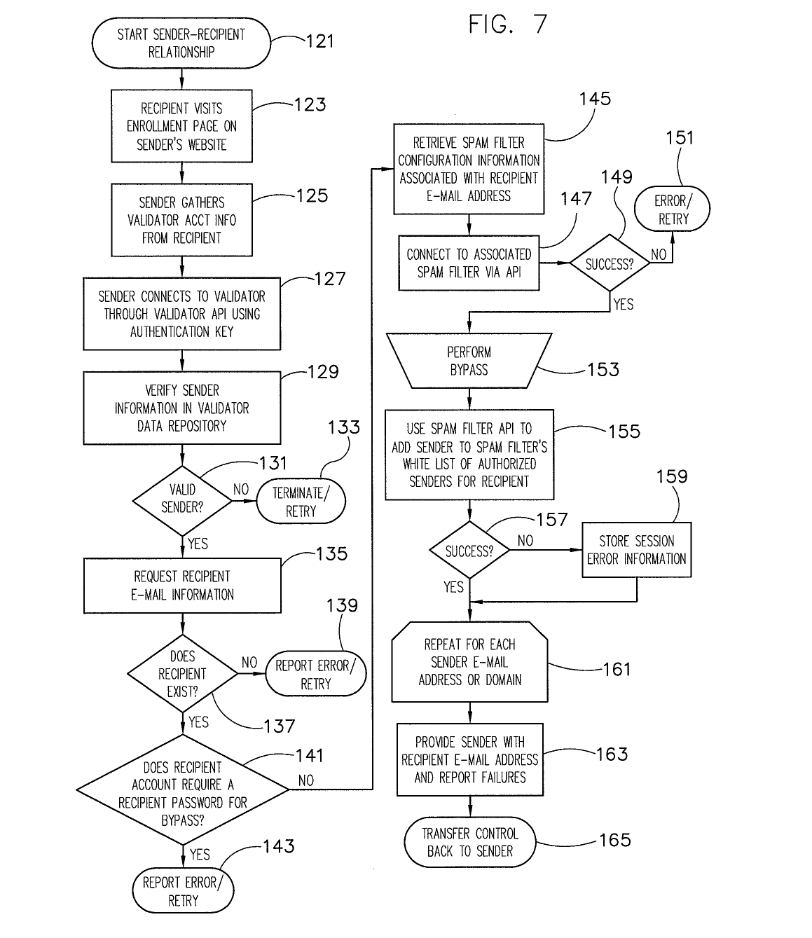

FIG. 7 shows a flow chart of a process of creating a relationship between a sender 18 and a recipient 20 according to an embodiment of the present invention. In the embodiment shown in FIG. 7, the relationship-formation process begins (step 121) with the recipient visiting an enrollment page (not shown) on the Web site of the sender 18 (step 123). By way of their Web site, the sender 18 gathers information from the recipient 20 regarding the recipient's Validator 12 account (step 125), such as a Validator account number or other identification provided to the recipient by the Validator after their registration with the Validator. The sender 18 may also gather other Validator 12 registration information of the recipient 20 (step 125), such as their name or username. The sender 18 may provide this information of the recipient 20 to the Validator 12 while communicating with the Validator for establishing the sender-recipient relationship as described below.

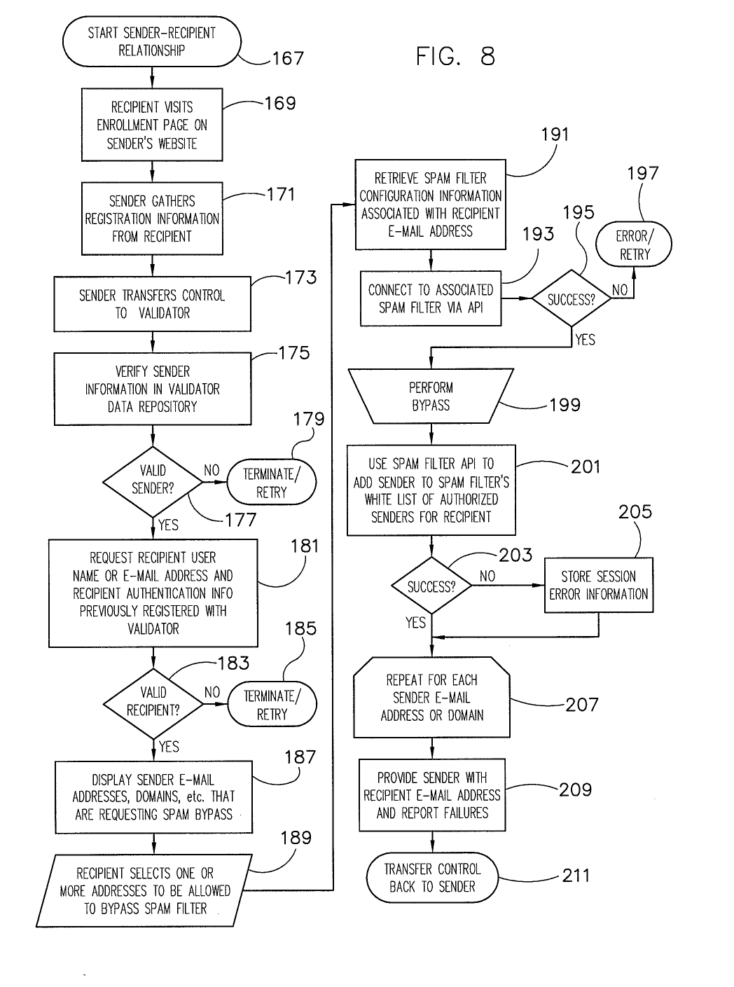

This process further includes the sender 18 connecting to the Validator 12 (step 127). The sender 18 may connect to the Validator 12 in a variety of ways without departing from the scope of the present invention. In one embodiment, for example, the sender 18 connects to the Validator 12 by way of an application programming interface (API). The API may be formed as part of the Validator 12 by a programmer creating or maintaining the Validator. An API is a source code intermediary provided by computer systems in connection with a program for supporting requests for services made to the computer system regarding the program. For example, regarding the present invention, an API is a source code intermediary provided by the Validator 12, particularly, or the communication system 10, generally, in connection with one or more Validator programs for supporting requests from senders 18 and recipients 20 for services including registrations and establishment of relationships made to the Validator/system. As part of the step of connecting to the Validator 12 (step 127), the computer system of the sender 18 may transfer control of the applications of the system of the sender and the corresponding API to the Validator (step not shown in FIG. 7; similar step shown at step 173 of FIG. 8). In one embodiment, it is preferred that the interface to the Web site of the Validator 12 and the Web site itself are especially secure. Methods of increasing the security of Web sites and interfaces (e.g., APIs) between them are well known and will not be described in detail here. By gaining control as described above, the Validator 12 may proceed to procure the required information from the appropriate applications on the sender's system and communicate with the spam filter 26 associated with the recipient 20. As will be appreciated by those skilled in the art, when the sender 18 transfers control of its applications, the sender may pass account information (e.g., account number) and encrypted key information to the Validator using any of a variety of methods including POST and GET. Whether the Validator 12 is solely controlling the respective applications and interface or the Validator and sender are jointly controlling the applications and interface, the steps of procuring recipient 20 information and communicating with the spam filter 26 remain essentially the same and are as follows.

In one embodiment, the sender 18 computer provides the encrypted key associated with the sender to the Validator 12 during the step of connecting to the Validator (step 127). The sender key may be presented automatically, such as by the sender's computer presenting the key to the Validator 18 when establishing a communication session without being requested or in response to a request.

After the sender 18 has connected to the Validator 12, the Validator verifies the sender's information is accurate (step 129). For example, the Validator 12 may ensure that the key presented by the sender 18 is valid and also request and confirm the accuracy of other authentication information such as username and password. If the Validator 12 determines (step 131) that the sender 18 has not provided accurate information, the Validator may terminate the connection or session (step 133). In cases of termination, the Validator 12 may first present a message (not shown) to the sender regarding the termination, such as, “Authentication failure; Inaccurate data provided”. If the Validator 12 authenticates the sender 18 (steps 129, 131), the Validator then requests names, usernames, and/or e-mail addresses associated with the recipient 20 with whom the sender wishes to create the relationship (step 135). At this stage, the Validator 12 may also request authentication information (e.g., encrypted keys, passwords) associated with the account of the recipient 20.

Upon receiving the requested information associated with the recipient 20 (e.g., e-mail address) from the sender 18, the Validator 12 determines whether the address corresponds to a valid registered recipient (step 137). If the information provided regarding the recipient 20 by the sender 18 does not match the registered accounts that the Validator 12 has stored in its memory 38 or database 47, the Validator will report an error (step 139) to the sender 18 and may terminate the connection or session. As an alternate to reporting an error at this stage (step 139), the Validator 12 may be configured to allow the sender 18 to interact with the recipient 20 for registering the recipient with the Validator. For example, the Validator 12 may advise the sender 18 that the presented recipient 20 does not have an account and the sender may communicate with the sender at this time to register the recipient. As will be appreciated by those skilled in the art, such a registration—of a recipient 20 that is enrolling with a sender 18 who is in turn attempting to create a relationship with the recipient in the Validator—may be accomplished in numerous ways. For example, upon receiving the message from the Validator 12 that the intended recipient 20 is not a Validator member, the sender 18 may in turn advise the sender to access the Validator on-line (e.g., the Web page shown in FIG. 6), register, and return to the sender to confirm completion of their registration. In the event that the Validator 12 or the sender 12 system are programmed to disconnect from each other during long spells of inactivity between them, such as while the registering recipient 20 is registering, they may later reconnect for completing the process. In the event of disconnect, the Validator may report an error due to a failed attempt to create a relationship (step 139). In the event of an error, the sender 18 can retry establishing the relationship in the Validator 12 and respective spam filter 26 after the recipient has created an account with the Validator.

As another method of registering the to-be recipient 20 during the process of creating a relationship between the recipient and the respective sender 18, the Validator 12 may reach through the system of the sender 18 to the recipient 20 and present a pop-up window to the recipient for registering, such as via the Web page shown in FIG. 6. The Validator 12 may also contact the recipient 20 directly and separate from the connection between the Validator and the sender for presenting such a Web page. For example, the Validator 12 may, separate from its connection to the sender 18, generate a pop-up window on a display of the recipient 20 or send the recipient an e-mail with a link to such a pop-up. As stated, other methods of attempting to register the to-be recipient 20 during or related to the attempt of the sender 18 to create a relationship in the Validator with that recipient will be apparent to those skilled in the art and, accordingly, will not be described in further detail.

If the information provided regarding the recipient 20 by the sender 18 matches a registered recipient account that the Validator 12 has stored in its memory 38 or database 47, the Validator will review that recipient's account to determine if the account has a password bypass (step 141). A password bypass is an indication that a recipient 20 may put on their account while registering with the Validator 12 or thereafter allowing sender's to establish a relationship with them through the Validator without the sender 18 or recipient having to present a password of the recipient when establishing the relationship. The Validator 12 may be configured to allow recipients 20 to provide password bypass authorizations for some senders 18 of whom they approve but not for others. If the Validator account of the recipient 20 does not have a password bypass, then the Validator 12 may request the password from the sender. The sender 18 may have the password of the recipient 20 because, for example, the recipient provided it to the sender while enrolling at the sender Web site (step 123, 125) despite not providing a password bypass in the Validator 12. Using encryption technology, the recipient 20 may be able to provide their password to the sender 18 in a secure form so the sender cannot determine the password but can pass it onto the Validator for approval at the password step (step 141). Alternatively, the recipient 20 could log onto the Validator 12, add the password bypass, and advise the sender 18 of the same, and then the sender can initiate creation of the relationship (step 121).

If the account of the recipient 20 does not include a password bypass and the sender 18 does not have the password, then the Validator 12 presents an error message and terminates the connection or session (step 143). In some embodiments of the present invention, the Validator 12 is configured to interact with the recipient 20 directly at this stage for authorizing the particular sender 18 (see e.g., step 187 of FIG. 8).

If the Validator account of the recipient 20 has a password bypass associated with all senders or at least the particular sender 18 or if the sender has the password, a child record is created under the parent record for this recipient with respect to this sender. The Validator 12 continues the process of establishing the relationship by retrieving configuration information for the spam filter 26 (shown in FIG. 1) stored in its memory 38 or database 47 (step 145). The Validator 12 procures the configuration information for the spam filter 26 associated with the recipient 20 e-mail address during registration of the recipient (see e.g., step 105 of FIG. 5).

After the Validator 12 has retrieved the appropriate spam filter 26 configuration information, the Validator attempts to connect to the spam filter via an application programming interface (API) (step 147). APIs were described above and their use is well known in the art. The Validator 12 procures the configuration information during the registration process for the recipient 20. Specifically, after the Validator 12 determines the appropriate spam filer 26, the Validator contacts the filter to establish a relationship between the Validator and the filter (or between the Validator and the ISP 22 running the filter). By this relationship, the Validator 12 and the filter 26/ISP 22 agree that the filter will allow the Validator to add and remove senders from the approved list or “white list” associated with one or more particular recipients or that the filter/ISP will add and remove such senders upon instruction from the Validator. The white list of the spam filter 26 to which the Validator 12 adds the sender information may be a list that the spam filter maintains before it begins working with the Validator. For example, the spam filter 26, as part of its usual operation, may maintain a white list and, as part of working with the Validator, may allow the Validator to add names thereto. Alternatively, the spam filter 26 may create a white list, or allow the Validator 12 to create a white list in its system, that is separate from its (i.e., the filter's) list of authorized senders to the recipient. In either event, the pre-established relationship between the Validator 12 and the ISP 22 (e.g., see step 105 of FIG. 5) allows the Validator to later connect to the spam filter via established API (in step 199, 201) for adding, or instructing the filter or its operator to add, the particular sender 18 whom the particular recipient 20 elected as an authorized sender in the Validator.

Part of the Validator 12 and the ISP 22 establishing this relationship is the Validator and filter agreeing on communication features, such as interfaces and protocols to be used between them, and security features. The Validator 12 may have security information such as an encrypted key recognized by the spam filter 26 (e.g., filter of the ISP) as being associated with the Validator and perhaps being associated with the Validator and a particular recipient 20. The security information can be created by the Validator 12 or the ISP 22 and stored in each. When the Validator 12 contacts the ISP 22, the ISP can recognize the Validator and perhaps recognize about which ISP customer (i.e., recipient) the Validator is calling.

If the Validator 12 determines (step 149) that a connection to the spam filter 26 associated with the particular recipient 20 was not made, the Validator may determine that an error has occurred (step 151). If the Validator 12 determines (step 149) that it has successfully connected to the spam filter 26, then the Validator proceeds to implement a bypass within the spam filter for e-mails from the particular sender 18 (step 153). Particularly, the Validator 12 may use the aforementioned API of the spam filter 26 (or ISP 22) to connect with the filter to add, or instruct the filter/ISP to add, the particular sender's e-mail or domain information—depending on whether the recipient 20 authorized the sender to send from one or more e-mails and/or from one or more domains—to the white list the filter maintains for e-mail addresses from which e-mails pass through to the recipient's in-box 28 (shown in FIG. 1) or other preferred box or folder instead of their spam folder 30 (step 155). The white list of the spam filter 26 that the Validator 12 adds the sender 18 information to may be a list that the spam filter has before it begins working with the Validator. For example, the spam filter 26, as part of its usual operation, may include a white list and, as part of working with the Validator, may allow the Validator to add names to the white list. Alternatively, the spam filter 26 may create a white list, or allow the Validator 12 to create a white list in its system, that is separate from its list of authorized senders to the recipient. In either event, the pre-established relationship between the Validator 12 and the spam filter 26 (see e.g., step 105 of FIG. 5) allows the Validator to later connect to the spam filter via an API (in step 153, 155) for adding the particular sender 18 that the particular recipient 20 elected as an authorized sender in the Validator. The APIs associated with the communication system 10 of the present invention, such as those in the Validator 12 through which the senders 18 and recipients 20 communicates with the Validator or those in the ISP 22, may be preexisting APIs or APIs custom created for use between the Validator and the members and/or between the Validator and the ISP. Forming and implementing custom APIs are well known in the art.

After attempting to add the e-mail information associated with the sender 18 to the appropriate white list of the spam filter 26 (step 155), the Validator 12 considers whether the addition was successful (step 157). If the Validator 12 determines that it did not successfully add the e-mail information associated with the sender 18 to the white list of the filter 26, the Validator stores an error message in its memory 38 or database 47 regarding the session (step 159). Upon failure to add an e-mail address of the sender 18 to the appropriate white list of the filter 26, the Validator 12 may be configured to retry adding the e-mail address to the list a specified number of times. After one or more failed attempts to add an e-mail address of the sender 18 to the appropriate white list of the filter 26 or after a successfully addition of a sender e-mail address, the Validator 12 repeats the e-mail address addition steps (e.g., steps 153, 155, 157, 159) for each e-mail address of the sender from which the recipient 20 agreed via the Validator to receive e-mails (step 161). In one embodiment, this repeat step (step 161) includes repeating the steps between and including retrieving ISP/filter configuration information associated with respective e-mail addresses (step 145) and the steps of determining success of adding the sender 18 to the white list of the ISP/filter (e.g., steps 157, 159).

The ISP 22 or other operator of the filter 26 may notify the Validator 12 that the e-mail address(es) or domain(s) have been added to the white list of the filter. After the Validator 12 has attempted to add each e-mail address or domain of the sender 18 to the appropriate white list of the recipient's spam filter 26, the Validator 12 may provide the sender with the e-mail address(es) of the recipient 20 to which the sender is now authorized in the filter to send e-mails and the e-mail address(es) from which of they may send (step 163). After the Validator 12 has attempted to add each e-mail address or domain of the sender 18 to the appropriate white list of the spam filter 26 of the recipient 20, the Validator 12 may also present information regarding any errors that occurred during the process of establishing the particular relationship, such as failure to add an e-mail address of the sender to the white list of the filter (step 163).

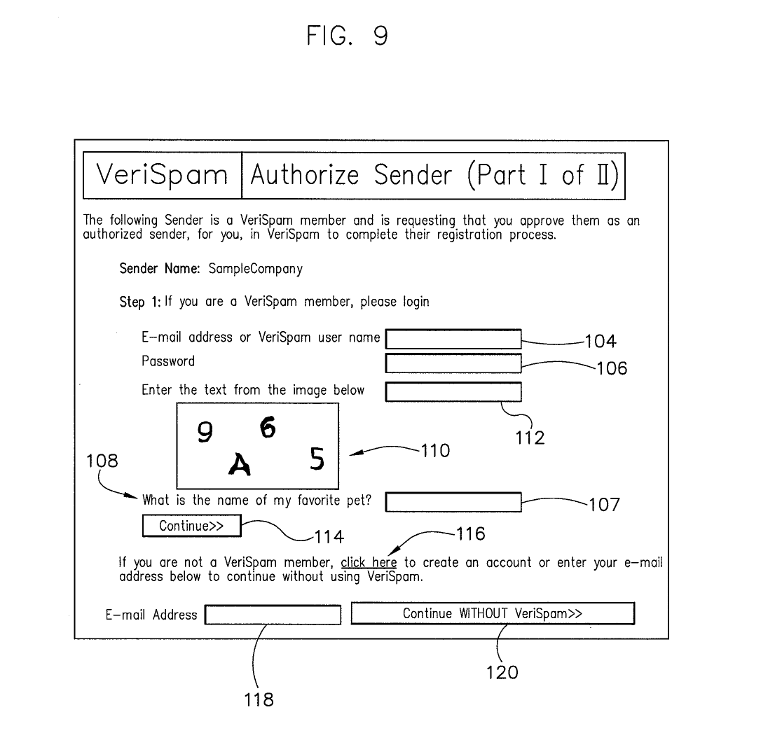

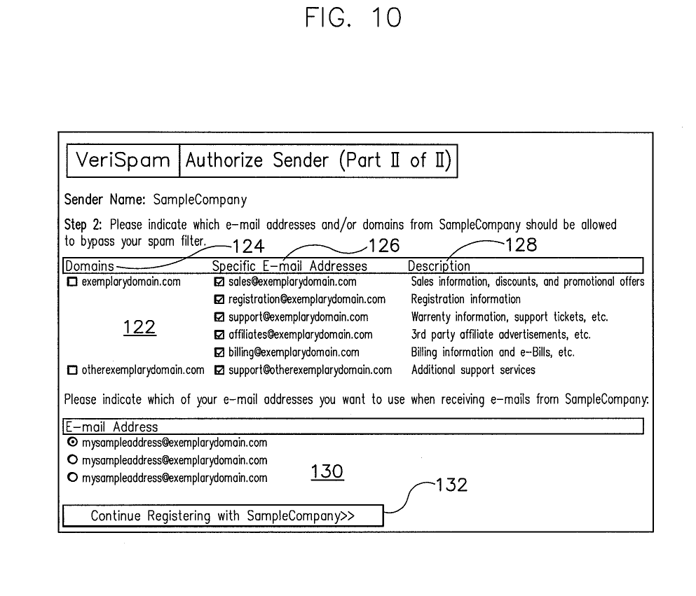

The recipient 20 may also remove senders 18 they previously authorized through the Validator 12. For example, the recipient 20 may access the same or similar Web page forms of the Validator 12 as shown in FIGS. 9 and 10 and remove one or more e-mail addresses or domain names associated with a sender 18. The Validator 12 then removes or requests the ISP/filter to remove the corresponding addresses/domain names from the white list in steps similar to steps 145-161 and 191-207, described with respect to FIGS. 7 and 8, respectively. The Validator 12 may be configured to advise the sender 18 of such removals, such as in a step similar to steps 163 and 209, described with respect to FIGS. 7 and 8, respectively. The Validator 12 may also be configured to present the recipient 20 removing the sender 18 with an option of notifying the sender being removed or not notifying them of the removal.

After creating a relationship according to the aforementioned embodiment (or unsuccessfully attempting to create the relationship), the Validator 12 may return control of the sender applications that were tied to the API of the Validator during the relationship-creation process to the sender (step 165). In this way, the Validator 12 ends the session and connection between the sender and the Validator.

In some embodiments of the present invention, the Validator 18 may require the recipient to more actively participate in the process of creating the relationship while enrolling with the sender 18 regarding the sender's products or services. These embodiments of the Validator may be used when, for example, the registered recipient 20 is not given the option of providing a password bypass (see e.g., step 141 of FIG. 7) or the recipient has elected not to provide a password bypass for any sender 18 or at least the particular sender seeking to establish a relationship at the time. FIG. 8 shows a flow chart of a process of creating a relationship between a sender 18 and a recipient 20 according to these embodiments of the present invention. In these embodiments, the relationship-formation process begins (step 167) with the recipient visiting an enrollment page (not shown) on the Web site of the sender 18 (step 169). By way of their Web site, the sender 18 then gathers information from the recipient 20 regarding the recipient's Validator 12 account (step 171), such as a Validator account number or other identification provided to the recipient by the Validator after their registration with the Validator. The sender 18 may also gather other Validator 12 registration information of the recipient 20 (step 171), such as their name or username. The sender 18 may provide this information of the recipient 20 to the Validator 12 while communicating with the Validator for establishing the sender-recipient relationship as described below.

The process further includes the sender 18 connecting to the Validator 12 (similar to step 127 of FIG. 7). The sender 18 may connect to the Validator 12 in a variety of ways without departing from the scope of the present invention. In one embodiment, for example, the sender 18 connects to the Validator 12 by way of an application programming interface (API). As part of the step of connecting to the Validator 12, the computer system of the sender 18 may transfer control of the applications of the system of the sender (i.e., programs installed on the system of the sender for interacting with the Validator) and the corresponding API to the Validator (step 173). In one embodiment, it is preferred that the interface to the Web site of the Validator 12 and the Web site itself are particular secure. Methods of increasing the security of Web sites and interfaces (e.g., APIs) between are well known and will not be described in further detail here. By having control, the Validator 12 may procure the required information from the appropriate applications on the sender's system and communicate with the spam filter 26 associated with the recipient. As will be appreciated by those skilled in the art, when the sender 18 transfers control of its applications, the sender may pass their account information (e.g., account number) and encrypted key information to the Validator using any of a variety of methods including POST and GET methods. Whether the Validator 12 is controlling the respective applications and interface or the Validator and sender 18 are jointly controlling the applications and interface, the steps of procuring recipient 20 information and communicating with the spam filter 26 remain essentially the same and are as follows.

In one embodiment, the sender 18 computer provides the encrypted key associated with the sender to the Validator 12 during the step of connecting to the Validator. Presentation of the key of the sender 18 may occur automatically, such as when the sender's computer presents the key to the Validator 18, without request or in response to a request.

After the sender 18 has connected to the Validator 12, the Validator verifies that the sender's information is accurate (step 175). For example, the Validator 12 may ensure that the key presented by the sender 18 is valid and also request and confirm the accuracy of other authentication information such as username and password. If the Validator 12 determines (step 177) that the sender 18 has not provided accurate information, the Validator may terminate the connection or session (step 179). In cases of termination, the Validator 12 may first present a message (not shown) to the sender regarding the termination, such as, “Authentication failure; Inaccurate data provided”. If the Validator 12 authenticates the sender 18 (steps 175, 177), the Validator then requests names, usernames, and/or e-mail addresses related to the recipient 20 with whom the sender wishes to create the relationship (step 181). At this stage, the Validator 12 may also request authentication information (e.g., encrypted keys, passwords) associated with the account of the recipient 20.

Upon receiving the requested information associated with the recipient 20 (e.g., e-mail address) from the sender 18, the Validator 12 determines whether the address corresponds to a valid registered recipient 20 (step 183). If the information provided regarding the recipient 20 by the sender 18 does not match the registered accounts that the Validator 12 has stored in its memory 38 or database 47, the Validator will report an error to the sender and may terminate the connection or session (step 185). As an alternate to reporting an error at this stage (step 185), the Validator 12 may be configured to allow the sender 18 to interact with the recipient 20 for registering the recipient with the Validator. Methods of registering the recipient 20 with the Validator 12 as part of the process of creating a relationship between the sender 18 and the recipient in the Validator are described above regarding the embodiment shown in FIG. 7 (specifically regarding step 139) and will not be described in further detail.

If the information provided regarding the recipient 20 by the sender 18 matches a registered recipient account in the Validator 12, the Validator, according to this embodiment, then displays a Web page to the recipient 20 allowing the recipient to confirm their identify and confirm their desire to create the relationship with the sender (step 187). FIG. 9 shows an exemplary Web page presented by the Validator 12 to the recipient 20 for confirming the recipient's identify and desire to create the relationship. Methods by which the Validator 12 may present such page are well known in the art. For example, as described above, the Validator 12 may reach through the system of the sender 18 to the recipient 20 and present a pop-up window to the recipient. The Validator 12 may also contact the recipient 20 directly and separate from the connection between the Validator and the sender for presenting such a Web page. For example, the Validator 12 may generate a pop-up window on a display of the recipient 20 or send the recipient an e-mail with a link to such a pop-up.

After the Validator 12 presents a Web page form such as that shown in FIG. 9 to the recipient 20 (step 187), the recipient completes the form (step 189). Through the form, the Validator 12 may request information including the e-mail address or Validator username of the recipient 20 in an identification field 104. The Validator 12 may also request other authentication information of the recipient 20 such as a password 106 and/or an answer 107 to a secret question 108. The Validator 12 may also present a scrambled-text display 110 readable by a person and a scrambled-text field 112 into which the recipient 20 must enter the text of the scrambled-text display. After completing the requested authentication information including the aforementioned fields 104-112 (even numbers) and any other fields the Validator 12 may present, the recipient 20 selects the continue button 114 for continuing the process of authorizing the particular sender 18.

As shown in FIG. 9, the Validator 12 may present a link 116 for users that are not members of the Validator to a registration form, such as that shown in FIG. 6. The Validator 12 may also present an e-mail address field 118 and an associated button 120 for non-members wishing to continue enrolling with the sender 18 (e.g., for procuring products, services, or information from the sender) without using the Validator. In other words, under this option, the entity that the sender 18 was attempting to establish a relationship with through the Validator 12 may elect to continue enrollment with the sender without using the Validator. Some senders 18, however, may not allow their enrollees to enroll without a Validator relationship to avoid, for example, the shortcomings of conventional e-mail communication systems described above in the Background of the Invention section.

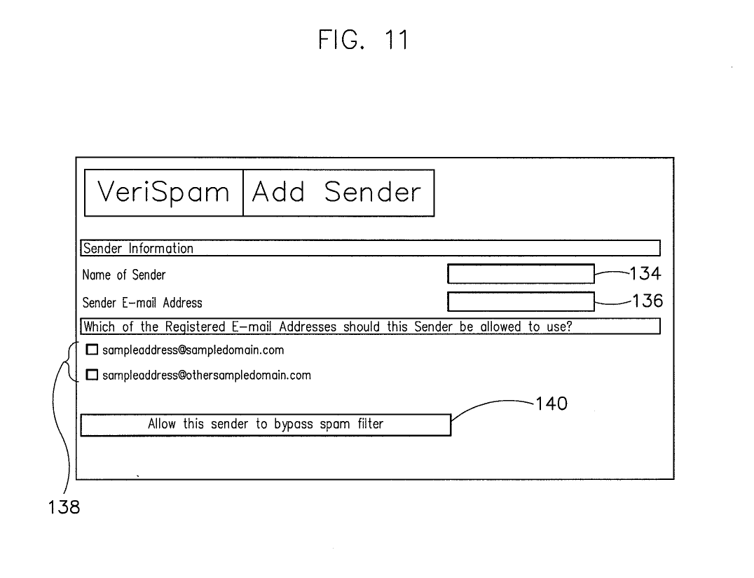

FIGS. 10 and 11 show first and second Web page forms that the recipient 20 may complete to establish the relationship with the particular sender 18. This form includes a sender e-mail information section 122 in which the recipient 20 selects which domains 124 and/or e-mail addresses 126 of the particular sender 18 from which the recipient agrees to receive communication. In this section 122, the Validator 12 may also present a “select all” box (not shown) by which the recipient 20 may select all of the other options in the section. The Validator 12 may also present an option (which can be called a “blanket approval” option) to the recipient 20 whereby the recipient may authorize all communications from the sender 18, such as authorizing all current and future e-mail addresses associated with the sender. The Validator 12 may also present descriptions 128 for the domains 124 and/or e-mail addresses presented in the sender e-mail information section 122.

Further, the Validator 12 may present a recipient e-mail information section 130 in which all of the registered e-mail addresses of the recipient are displayed. In this section 130, the recipient 20 selects the e-mail addresses to which they are agreeing to receive e-mail messages from this sender (i.e., agreeing to let the Validator add this sender to the respective white list of the spam filter). This section 130 may also include a “select all” option. After completing the selections in these e-mail information sections 122, 130, the recipient 20 may select a button 132 to complete the process of authorizing the sender. The Validator 12 may be configured to send the recipient 20 back to the Web site of the sender 18.

After the recipient 20 has authorized the sender in the Validator 12 as described in the immediately preceding paragraphs, a child record is created for this recipient associated with this particular sender under the parent record of this recipient. Also, the Validator 12 continues the process of establishing the relationship between the sender 18 and the recipient by retrieving configuration information for the spam filter 26 (shown in FIG. 1) from its memory 38 and/or database 47 (step 191). The Validator 12 procures the configuration information for the spam filter 26 associated with the recipient 20 e-mail address during registration of the recipient, as shown, for example, at step 105 of FIG. 5.

After the Validator 12 has retrieved configuration information for the appropriate spam filter 26, the Validator attempts to connect to the spam filter via an application programming interface (API) (step 193). APIs are described above and their use is well known in the art. If the Validator 12 determines (step 195) that a connection to the spam filter 26 associated with the particular recipient 20 was not made, the Validator concludes that an error has occurred (step 197). If the Validator 12 determines (step 195) that it has successfully connected to the spam filter 26, then the Validator proceeds to implement a bypass within the spam filter for e-mails from the particular sender 18 (step 199). Particularly, the Validator 12 may use the aforementioned API of the spam filter 26 to add the particular sender's e-mail or domain information to a white list that the filter maintains regarding the particular recipient (step 201). The white list of the spam filter 26 to which the Validator 12 adds the sender 18 information may be the list that the spam filter created without regard for the Validator or a list set up especially for use with the Validator as described above regarding other embodiments of the invention. In either event, the pre-established relationship between the Validator 12 and the ISP 22 (e.g., see step 105 of FIG. 5) allows the Validator to later connect to the spam filter via established API (in step 199, 201) for adding the particular sender 18 whom the particular recipient 20 elected as an authorized sender in the Validator.

After attempting to add the e-mail information associated with the sender 18 to the appropriate white list of the spam filter 26 (step 201), the Validator 12 considers whether the addition was successful (step 203). If the Validator 12 determines that it did not successfully add the e-mail information associated with the sender 18 to the white list of the filter 26, the Validator stores an error message in its memory 38 or database 47 regarding the session (step 205). Upon failure to add an e-mail address of the sender 18 to the appropriate white list of the filter 26, the Validator 12 may be configured to retry adding the e-mail address the list a specified number of times. After one or more failed attempts or after successfully adding a sender's e-mail address, the Validator 12 repeats the addition steps (e.g., steps 199, 201, 203, 205) for each e-mail address of the sender that the recipient 20 agreed via the Validator to receive e-mails from (step 207).

After the Validator 12 has attempted to add each e-mail address or domain of the sender 18 to the appropriate white list of the spam filter 26 of the recipient 20, the Validator 12 may provide the sender with the e-mail address(es) of the recipient to which the sender is now authorized in the filter to send e-mails and the sender e-mail addresses from which they can send (step 209). After the Validator 12 has attempted to add each e-mail address or domain of the sender 18 to the appropriate white list of the spam filter 26 of the recipient 20, the Validator 12 may also present information regarding any errors that occurred during the process of establishing the particular relationship, such as failure to add an e-mail address of the sender to the white list of the filter (step 209). After creating a relationship according to the aforementioned embodiment (or unsuccessfully attempting to create the relationship), the Validator 12 may return control of the sender applications that were tied to the API of the Validator during the relationship-creation process to the sender (step 211). In this way, the Validator 12 ends the session and connection between the sender and the Validator.

As mentioned above, the recipient 20 may also remove senders 18 they previously authorized through the Validator 12. For example, the recipient 20 may access the same or similar Web page forms of the Validator 12 as shown in FIGS. 9 and 10 and remove one or more e-mail addresses or domain names associated with a sender 18. The Validator 12 then removes or requests the ISP/filter to remove the corresponding addresses/domain names from the white list in steps similar to steps 145-161 and 191-207, described with respect to FIGS. 7 and 8, respectively. The Validator 12 may be configured to advise the sender 18 of such removals, such as in a step similar to steps 163 and 209, described with respect to FIGS. 7 and 8, respectively. The Validator 12 may also be configured to present the recipient 20 removing the sender 18 with an option of notifying the sender being removed or not notifying them of the removal.

In one embodiment of the present invention, instead of a relationship between a particular sender 18 and a particular recipient 20 being created during a process of the recipient enrolling with the sender, the registered recipient may establish the relationship on their own through the Validator 12 as follows. FIG. 11 shows a Web page form that the Validator 12 may present to a registered recipient 20 logging onto the Validator and seeking to authorize a sender 18. In this form, the Validator 12 may present a sender name field 134 for the authorizing recipient 20 to complete. The Validator 12 may also present a field 136 requesting the e-mail address of the sender 18 being authorized by the recipient 20. Although not shown in FIG. 11, the Validator 12 may present domains and e-mail addresses for a sender 18 (such as those shown in the sender information section 122 of FIG. 10) once the Validator determines the sender the recipient is attempting to authorize. For example, the Validator 12 may recognize the sender 18 whom the recipient 20 is attempting to authorize once the recipient enters the sender's name and/or e-mail information.

The Validator 12 may also present the e-mail addresses 138 of the recipient 20, from which the recipient selects the addresses to which the sender 18 may send e-mails. Upon completion of the fields 134, 136, 138 in this form, the recipient may select an add sender button 140 to complete the authorization and add the sender as an authorized sender. This is yet another way by which a child record for the recipient 20 associated with a particular sender is created under the parent record of the recipient. Upon creation of this new child record, the Validator 12 proceeds with the process of ensuring the sender's e-mails bypass the recipient's filter 26, as described above regarding the embodiments exemplified in FIGS. 7 and 8. For example, the Validator 12 may retrieve filter configuration information, such as performed in step 145 of FIG. 7 and step 193 of FIG. 8. The Validator 12 may then connect to the filter via existing or custom APIs (e.g., steps 147 of FIG. 7 and 193 of FIG. 8) and attempt to perform the requested filter bypasses (e.g., steps 153-163 of FIG. 7 and steps 199-209 of FIG. 8).

The Validator 12 may present the Web page form for authorizing a sender shown in FIG. 11 under a variety of circumstances within the scope of the present invention. For example, a registered recipient 20 may access the form by logging onto the Validator 12 and requesting to add a sender 18. As another example, during a process of enrolling for information or services of a sender 18, the recipient 20 may select a link on the Web page of the enrolling sender that links to a Web page form such as that shown in FIG. 11 or FIGS. 9 and 10, as described above. As another example, the Validator 12 may send the recipient 20 an e-mail in response to a request from the sender 18, the e-mail having a link to a generic or sender-specific Web page form of the Validator. A sender-specific Web page form may include, for example, pre-completed fields and/or sender-specific options, such as option boxes next to the domains and/or e-mail address for the specific sender (similar to those shown in the sender e-mail information section 122 of FIG. 10).

During operation of the communication system 10, e-mail of a particular registered sender 18 reliably bypasses the spam folder 30 and arrives at the in-box 28 or other preferred box or folder of the spam filter 26 associated with a particular registered recipient 20 with whom the particular sender has established a relationship in the Validator 12 because the Validator has added the sender to the white list of the spam filter. In some embodiments of the communication system 10, the sender 18 is required to send the Validator 12 a carbon copy (i.e., “cc:”) of every or at least a first e-mail sent to the recipient 20 with whom the sender has established a relationship so the Validator can notify the ISP 22 to allow the e-mail or all e-mails from this sender to the particular recipient through the spam filter 26 and to the in-box 28. In some cases, the filter 26 first delivers the incoming e-mail to the spam folder 30 and then moves the e-mail to the in-box 28 upon receipt of the e-mail from the Validator 12 requesting delivery of the particular sender's e-mail.

In another embodiment of the communication system 10 according to the present invention, the Validator 12 establishes a relationship with the spam filter 26, or the ISP 22, whereby the ISP allows all e-mails from the Validator to pass through the filter to the specified recipients 20. The ISP 22 may recognize the e-mails of the Validator by, for example, the particular domain from which the e-mails are sent. For example, the Validator 12 may send all of its e-mails to an ISP 22 using e-mail addresses (e.g., admin@ValidatorDomain.com) of a particular domain (e.g., ValidatorDomain.com). In this embodiment, registered senders 18 will send e-mails intended for particular recipients 20 to an e-mail address of the Validator 12, wherein the e-mail has indicia that is unique to the intended recipient. Such indicia may be, for example, in the preamble of the e-mail address to which the message is being sent, in the domain portion of that e-mail address, or in the subject line of the address. For instance, the Validator 12 may create an e-mail account unique to a recipient 20 (e.g., ForRecipient123@ValidatorDomain.com) and recognize that every e-mail it receives to that address is for the corresponding recipient (e.g., Recipient123). The Validator 12 in turn forwards the e-mail to the intended recipient 20. The e-mail that the Validator 12 forwards to the recipient 20 bypasses the filter 26 because the filter has already agreed to let all e-mails from the Validator pass. One of the many benefits of this embodiment is that the Validator 12 would not be required to contact the ISP 22 for adding new senders 18 to the white lists of the IPS regarding recipients 20. Instead, the Validator 12 can just store established relationships created between particular senders 18 and particular recipients 20 in its memory 38 or database 47, create custom e-mail accounts associated with the recipients, and forward e-mails received to those addresses to the respective recipients. Another of the many benefits of this embodiment is that recipients' e-mail addresses may be kept private. For example, recipients 20 can establish relationships with senders 18 through the Validator 12 without the senders knowing their actual e-mail address, but rather only knowing their alias address established in the Validator. The Validator 12 may also be configured so recipients 20 can reply to senders 18 through the Validator by e-mails that do not communicate the recipient's actual e-mail address.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A method performed by a validator computer system for facilitating electronic communications from a sender to an electronic message program associated with a recipient, the method comprising:
registering the sender in the validator system;
registering the recipient in the validator system;
receiving approval from the recipient to designate the sender as an authorized sender for the recipient in the validator system;
designating the approved sender as an authorized sender for the recipient in the validator system in response to said approval from the recipient; and
communicating with a message filter associated with the message program associated with the recipient to add the sender to an authorized sender list of the filter.

2. A method as set forth in claim 1 wherein the validator system includes a database and the step of registering the sender in the validator system includes:
receiving from the sender authentication information including at least one authentication data item selected from a group of authentication data items consisting of a username, a password, a personal question, and a personal answer; and
recording the authentication information provided by the sender in the database of the validator.

3. A method as set forth in claim 1 wherein the validator system includes a database and the step of registering the sender in the validator system includes:
receiving from the sender registration information including at least one registration data item selected from a group of registration data items consisting of a name of the sender, a physical address of the sender, and a phone number for the sender; and
recording the registration information provided by the sender in the database of the validator.

4. A method as set forth in claim 3 wherein the step of receiving registration information from the sender includes receiving at least one e-mail address of the sender and the method further comprises:
receiving a request from the sender to change the e-mail address of the sender to a new e-mail address of the sender in the validator; and
notifying each recipient who has approved the senders as an authorized sender of the new e-mail address of the sender.

5. A method as set forth in claim 3 wherein the step of receiving registration information from the sender includes receiving at least one e-mail address from the sender and the method further comprises:
receiving a request from the sender to change the e-mail address of the sender to a new e-mail address of the sender in the validator; and
communicating with the message filter associated with the message program associated with the recipient to add the new e-mail address of the sender to the authorized sender list of the message filter.

6. A method as set forth in claim 1 wherein the step of registering the recipient in the validator system includes:
receiving from the recipient registration information including at least one registration data item selected from a group of registration data items consisting of a name of the recipient, a physical address of the recipient, and a phone number for the recipient; and
recording the registration information provided by the sender in a database of the validator.

7. A method as set forth in claim 6 wherein the step of receiving registration information from the recipient includes receiving at least one e-mail address from the recipient and the method further comprises:
receiving a request from the recipient to change the e-mail address of the recipient to a new e-mail address of the recipient in the validator; and
notifying each authorized sender associated with the recipient of the new e-mail address of the recipient.

8. A method as set forth in claim 6 wherein the step of receiving registration information from the recipient includes receiving at least one e-mail address from the recipient and the method further comprises:
receiving a request from the recipient to change the e-mail address of the recipient to a new e-mail address of the recipient in the validator; and
communicating with a message filter associated with a message program associated with the new e-mail address of the recipient to add the sender to an authorized sender list of the message filter associated with the new e-mail address of the recipient.

9. A method as set forth in claim 1 wherein the validator system includes a database and the validator system registering the recipient in the validator system includes:
receiving from the recipient authentication information including at least one authentication data item selected from a group of authentication data items consisting of a username, a password, a personal question, and a personal answer; and
recording the authentication information provided by the recipient in the database of the validator.

10. A method as set forth in claim 1 further comprising:
providing a unique electronic key to the sender for accessing the validator system; and
granting access to the sender when the sender presents said unique electronic key to the validator system.

11. A method as set forth in claim 1 further comprising:
providing a unique electronic key to the recipient for accessing the validator system; and
granting access to the recipient when the recipient presents said unique electronic key to the validator system.

12. A method as set forth in claim 1 further comprising:
registering additional senders in the validator system;
receiving approval from the recipient to designate the additional senders as authorized senders for the recipient in the validator system;
designating additional senders as authorized senders for the recipient in the validator system in response to said approval from the recipient; and
communicating with the message filter associated with the message program associated with the recipient to add the additional senders to the list of authorized senders of the filter for allowing electronic messages from the designated additional senders to pass to the in-box.

13. A method as set forth in claim 1 further comprising:
registering additional recipients in the validator system;
receiving approval from the additional recipients to designate the sender as an authorized sender for the additional recipients in the validator system;
designating the sender as an authorized sender for the additional recipients in the validator system in response to said approval from the additional recipients; and
communicating with message filters associated with message programs associated with the additional recipients to add the sender to respective lists of authorized senders maintained by respective message filters of the additional recipients for allowing electronic messages from the sender to pass to respective in-boxes for the additional recipients.

14. A method as set forth in claim 1 wherein the communicating step includes the validation system or the electronic message program adding the sender to the authorized sender list of the filter for allowing electronic messages from the sender to pass to an in-box of the electronic message program associated with the recipient.

15. A method as set forth in claim 1 wherein:
the receiving step includes receiving approval from the recipient to designate one or more e-mail addresses of the sender and/or one or more domain names of the sender as authorized;
the designating step includes designating the one or more approved e-mail addresses and domain names as authorized in the validator system;
the communicating step includes communicating with the message filter associated with the message program associated with the recipient to add the authorized e-mail addresses and/or domain names to the authorized sender list of the filter.

16. A method as set forth in claim 1 further comprising communicating with the message filter associated with the message program associated with the recipient to procure configuration information regarding the filter for facilitating communications between the validator system and the filter.

17. A method as set forth in claim 1 wherein each registering step includes:
presenting Web page forms to the sender and the recipient into which the sender and the recipient enter information for registering;
validating the entered information; and
recording the entered and validated information.

18. A method as set forth in claim 1 further comprising notifying the sender that they have been designated as an authorized sender in the validator system per recipient approval.

19. A method as set forth in claim 1 further comprising receiving confirmation from the filter associated with the recipient that the sender has been added to the authorized sender list of the message filter.

20. A method as set forth in claim 1 further comprising notifying the sender that they have been added to the authorized sender list of the message filter associated with the recipient.

21. A method as set forth in claim 1 further comprising enquiring of the recipient whether they want to approve the sender as an authorized sender, said enquiry being performed in response to a request of the sender for such an enquiry.

22. A method as set forth in claim 1 wherein said step of registering the recipient includes receiving registration information that the recipient entered into a Web site of the sender.

23. A method as set forth in claim 1 wherein said step of registering the recipient includes presenting a Web page form to the recipient in response to a request from the sender that the validator system present the Web page and/or in response to the recipient selecting a link in a Web site of the sender.

24. A method as set forth in claim 1 further comprising receiving control from the sender of programs and/or interfaces existing between the sender and the recipient, wherein at least one of the steps of registering the recipient and receiving approval are performed by the validator system by interacting with the recipient while having said control.

25. A method as set forth in claim 1 further comprising releasing said control of programs and/or interfaces between the sender and the recipient after the step of registering the recipient and/or the step of receiving approval.

26. A computer system for ensuring electronic communications from a sender are received to an in-box of an electronic message program associated with a recipient, the computer system comprising:
a processor running at least one program;
a database connected to the processor for storing information received from the processor and releasing the stored information to the processor upon request of the processor;
an input/output interface connected to the processor by way of an input/output data bus for connecting the processor to a wide area network;
a memory connected to said processor; and
an e-mail validation program stored in said non-volatile memory and ran by the processor wherein the processor running the program:
connects to the wide area network via said input/output interface;
requests and receives registration information from a sender via the wide area network;
stores the registration information received from the sender in the database;
requests and receives registration information from a recipient over the wide area network;
stores the registration information received from the recipient in the database;
receives approval from the recipient to designate the sender as an authorized sender for the recipient in the computer system over the wide area network;
designates the sender as an authorized sender for the recipient in the database in response to said approval from the recipient; and
communicates with a message filter associated with the message program associated with the recipient to add the sender to an authorized sender list in the filter.

27. A communication system for ensuring electronic communications from a sender are received to an in-box of an electronic message program associated a recipient, the communication system comprising:
a wide area network;
a sender computer operatively connected to the wide area network;
a recipient computer operatively connected to the wide area network;
an electronic message program associated with the sender computer;
an electronic message filter associated with the electronic message program; and
a validating computer connected to the wide area network and including:
a processor running at least one program;
a database connected to the processor; and
an e-mail validation program stored in said non-volatile memory and ran by the processor wherein the processor running the program:
connects to the wide area network via said input/output interface;
requests and receives registration information from a sender via the wide area network;
stores the registration information received from the sender in the database;
requests and receives registration information from a recipient over the wide area network;
stores the registration information received from the recipient in the database;
receives approval from the recipient to designate the sender as an authorized sender for the recipient in the validating computer over the wide area network;
designates the sender as an authorized sender for the recipient in the database in response to said approval from the recipient; and
communicates with a message filter associated with the message program associated with the recipient to add the sender to an authorized sender list in the filter.

28. A method performed by a validator computer system for facilitating electronic communications from a sender to an electronic message program associated with a recipient, the method comprising:
communicating with the electronic message program associated with the recipient to procure configuration information regarding the filter for facilitating communications between the validator system and the filter and to enable all electronic messages from the validator system to pass to whom the validator is sending the electronic messages;
registering the sender in the validator system;
registering the recipient in the validator system;
forming an alias e-mail address having a domain name of the validator system associated with a recipient having an actual e-mail address and storing the alias e-mail address and actual e-mail address and linking the addresses in a database of the validator system;
receiving approval from the recipient to designate the sender as an authorized sender for the recipient in the validator system;
receiving an electronic message from a transmitter to the alias address of the recipient;
ensuring that the transmitter of the electronic message to the alias address associated with the recipient has been approved by the recipient an authorized sender for the recipient in the validator system; and
forwarding the electronic message to the recipient if the transmitter of the message has been approved by the recipient as authorized sender for the recipient in the validator system.

29. A computer-readable medium product having computer program logic embodied therein for facilitating electronic communications from a sender to an electronic message program associated with a recipient, the computer program logic stored on the computer-readable medium to perform a method comprising:
registering the sender in the validator system;
registering the recipient in the validator system;
receiving approval from the recipient to designate the sender as an authorized sender for the recipient in the validator system;
designating the approved sender as an authorized sender for the recipient in the validator system in response to said approval from the recipient; and
communicating with a message filter associated with the message program associated with the recipient to add the sender to an authorized sender list of the filter.
